(19) United States
(12) Patent Application Publication
(10) Pub. No.: US 2017/0323361 A1
(43) Pub. Date: Nov. 9, 2017

(54) RAPID RE-HOSTING OF COLLABORATIVE BROWSING SESSIONS

(71) Applicant: Oct8ne Inc., Terrace Park, OH (US)

(72) Inventor: Domingo Obradors Giró, Barcelona (ES)

(21) Appl. No.: 15/148,299

(22) Filed: May 6, 2016

(51) Int. Cl. G06Q 30/06; H04L 29/08

(52) U.S. Cl. CPC G06Q 30/0617; H04L 67/02; G06Q 30/0629; G06Q 30/0631

(57) ABSTRACT

Session data from a first browsing session, of a first user of a first client device of a server, at an enterprise website is accessed. Session state data for the first browsing session is determined based on the session data. Information associated with the first user information is accessed from the enterprise, the first user information including first user contact information. A message is then transmitted to the first user, the message including a summary of the first browsing session generated based on the session data and the first user information. The message includes a link to a second browsing session at the enterprise website, and based on a selection of the link by the first user, the second browsing session is established. The session state data is used to establish an initial session state for the second browsing session including a browsing history of the first browsing session.

### TECHNICAL FIELD

The subject matter disclosed herein generally relates to providing a user with a way to preserve a session state across multiple collaborative browsing sessions. More specifically, the present disclosure describes systems and methods for transmitting a summary of a first browsing session to the user, the summary including a link to a second browsing session that can be initiated with a session state based on session state data from the first browsing session.

### BACKGROUND

A “browsing session” refers to a continuous connection (e.g., over a network) between a browser and a server over a period of time. Commercial web applications, such as e-commerce websites, generally track certain aspects of a user's activities and/or behaviors during a browsing session along with certain metadata associated with those activities and/or behaviors. Therefore, these web applications need the ability to maintain “state” information associated with the user's browsing session. Browsing session state data for an e-commerce website may include data such as: the last page of the website that the user visited or what actions the user took on a page of the website (e.g., adding an item to a shopping cart). Methods for storing data regarding a browsing session (including session state data) can include use of browsing session cookies or embedding data in URLs.

The e-commerce website stores user information over the course of a browsing session as the user travels from web page to web page at the web site. For example, a unique identification number may be assigned to the user so that the website can identify the user as the origin of requests to the server during the same browsing session. The unique identification number may be referred to as a user identifier (ID) or a session ID. The session ID (and/or a user ID) can be stored in a session ID cookie that is sent to a client device of the user and stored in a web browser of the client device of the user. The session ID (and/or a user ID) may be associated with browsing session state data stored at the server that hosts the e-commerce website and may also be associated with non-state-specific data stored at the server (e.g., contact information associated with the user). During a browsing session, if a request from the client device includes a session ID cookie, then the server knows that a browsing session has already been established and the server must check its stored data to identify data associated with the session ID. The client request can be executed based on the data associated with the session ID, and the browsing session can be updated accordingly. However, session 1p cookies are usually deleted from the browser of the client device when the browser is closed.

### BRIEF DESCRIPTION OF THE DRAWINGS

The present disclosure is illustrated by way of example, and not by way of limitation, in the figures of the accompanying drawings, in which:

FIG. 1 is a use-case diagram showing a network system configured to transmit data over a network and consistent with some embodiments for the rapid re-hosting of collaborative browsing sessions.

FIG. 2 is a block diagram depicting a network system having a client-server architecture, according to one embodiment, configured to provide a collaboration environment for the hosting of collaborative browsing sessions.

FIG. 3 is a block diagram depicting a network system having a client-server architecture, according to one embodiment, configured to provide a collaboration environment for the hosting of collaborative browsing sessions.

FIG. 4 is a block diagram depicting a network system having a client-server architecture, according to one embodiment, configured to provide a collaboration environment for the hosting of collaborative browsing sessions.

FIG. 5 shows a flow diagram illustrating one example embodiment of a method for the rapid re-hosting of collaborative browsing sessions.

FIG. 6 shows a flow diagram illustrating one example embodiment of a method for the rapid re-hosting of collaborative browsing sessions.

FIG. 7 shows a flow diagram illustrating one example embodiment of a method for the rapid re-hosting of collaborative browsing sessions.

FIG. 8 shows a diagrammatic representation of a machine in the example form of a machine or computer system within which a set of instructions may be executed causing the machine to perform any one or more of the methodologies discussed herein.

FIG. 9 is a block diagram illustrating a mobile device, according to an example embodiment.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

The shared manipulation of media files may be facilitated over a network in a platform-independent manner via a collaborative browsing session between multiple client devices. In other words, the client devices are not limited to using any particular operating system or other particular software in order to participate in a joint browsing session. As long as the client device has a browser type application for viewing/manipulating media files, for example, a hyper-text markup language (“HTML”) browser, it can join the collaborative browsing session. A link is established between the client devices and at least one server by using widgets (e.g., small software applications) that can be rapidly distributed from the server to requesting client devices. The widgets may be the same for two client devices to collaborate or the widgets may be different for a first client device (e.g., website customer) and a second client device (e.g., website sales agent). The second client device may already have such a widget if the user of the second client device is a sales agent; otherwise a “sales agent” widget can be provided by the server(s). The widgets allow communication (e.g., including transmission of media content) between the client devices and the server(s) (and therefore between the client devices via the server(s)) by using a server-generated collaboration user interface that enables the shared viewing/manipulating of files without requiring any particular software to be pre-installed on the client devices other than a browser for viewing media files.

According to an embodiment, a method for collaborative manipulation of media files may be invoked during a first browsing session of a customer at an electronic commerce (e-commerce) website. The client devices of the customer and a selected sales agent associated with the website may both display, on a browser of the respective client devices, a shared view of a media file in a collaboration user interface. In this way the customer and the sales agent can both view and manipulate the same media file displayed via a browser on their respective client devices. The server(s) accesses browsing session data (including session state data) of the first browsing session from an enterprise's e-commerce website and may also access customer data (e.g., contact information) from the enterprise, e.g., from an electronic customer relationship management (e-CRM) system of the enterprise. The session data may include data associated with goods or services the customer has searched or viewed during the first browsing session, information input into forms at the website (e.g., delivery information) and metadata about the first browsing session, such as a pattern of searches by the customer. The server(s) may determine from the accessed data, for example based on pre-determined matching rules, whether the customer might like to collaborate with a sales agent during the first browsing session. This determination may also simply be based on a customer request to collaborate with a sales agent.

The server(s) may then refer to data associated with available sales agents, for example data regarding their past performance, their product expertise, or previous interaction with the customer, in order to match the customer with at least one sales agent, based on the customer data, session data, and sales agent, and facilitate collaboration between the sales agent and the customer during the first browsing session as described above. The server(s) may also provide data regarding other sources of products or services the customer may be interested in viewing (both internal and external to the enterprise) for comparative purposes.

After the customer has ended the first browsing session at the e-commerce website, the server(s) may determine from the accessed data, for example based on an analysis of the session data (e.g., no purchase was made after extended browsing) and the customer data (e.g., this is unusual for the customer), that the customer was not satisfied with the results of the first browsing session. This determination may also be made based on input from the sales agent, for example based on new data (e.g., product that might satisfy a stated desire of the customer) discovered by the sales agent that might be helpful in steering the customer towards a purchase in a second browsing session. The server(s) or the sales agent can then transmit a message (e.g., e-mail) to the customer (e.g., based on accessed contact information), the message including a summary of the first browsing session. The summary of the first browsing session can include a list of viewed or searched products and a suggestion (e.g., based on input from sales agent or based on analysis of historical sales data) regarding a product or type of product that the customer may want to investigate (or further investigate if already viewed or searched in first browsing session) in a second browsing session at the e-commerce website.

In order to facilitate such a second browsing session, the transmitted message can include a link to the second browsing session, and the link can include (e.g., as embedded data in a URL of the e-commerce website) session state data for an initial session state of the second browsing session. For example, the second browsing session could begin with a specified product already in a shopping cart and delivery information already input into a form of the e-commerce website. Furthermore, the second browsing session could begin in a collaborative mode with the sales agent based on the session data indicating that the customer has collaborated with the second user during the first browsing session or based on historical data indicating that the customer has collaborated with the sales agent on previous occasions. In this way the customer's previous shopping experience (e.g., the first browsing session) can be continued without any cumbersome repetition of previous customer or sales agent actions (i.e., rapidly re-hosted at the server(s)) in a second browsing session with an initial session state that is customized based on all of the data available to the server(s), e.g., session, customer, and sales agent data.

### Overview

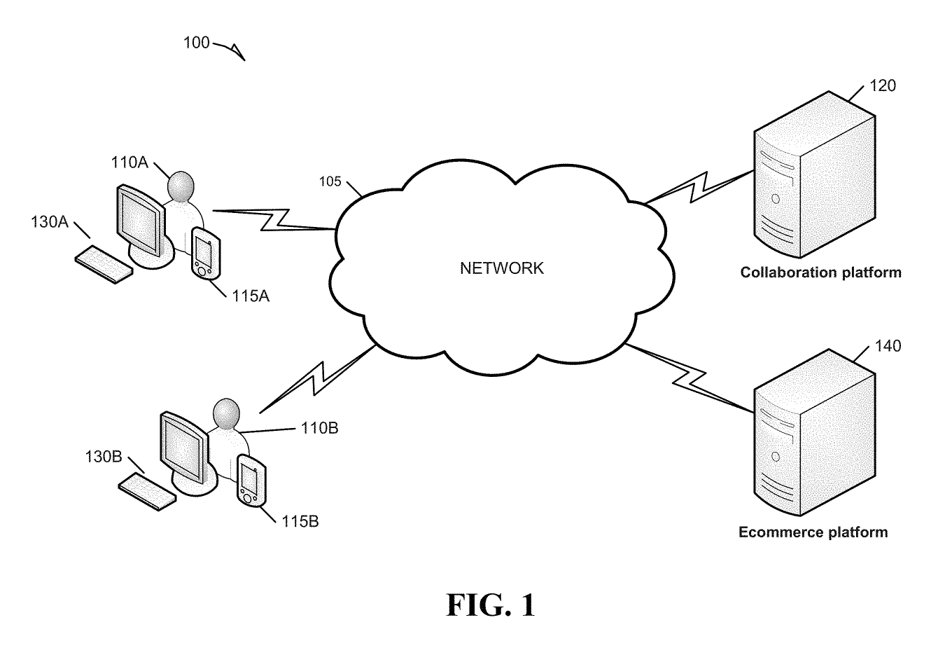

FIG. 1 is a use-case diagram showing a network system 100 configured to transmit data over a network 105 (e.g., the internet) and consistent with some embodiments for the rapid re-hosting of collaborative browsing sessions. At least one remote server 120 supports a collaboration platform for generating a collaboration user interface and for transmitting collaboration widgets to client devices 115 so that the client devices 115 can access the collaboration user interface. The client device 115A may be a mobile device or a more static client device 130A (e.g., a desktop computer) of a customer 110A of an e-commerce website of an ecommerce platform hosted at a platform server 140 accessed over network 105. The client device 115B may be a mobile device or a more static client device 130B of a sales agent 110B associated with the e-commerce website. The remote server 120 may access data associated with a first browsing session of customer 110A at the e-commerce website of the ecommerce platform hosted at a platform server 140, data associated with customer 110A, and data associated with available sales agents, for example sales agent 110B, in order to match the customer 110A with the sales agent 110B for a collaborative browsing session.

The remote server 120 can create a link between itself and the client devices (e.g., 130A and 130B) by transmitting collaboration widgets to the respective client devices 130A and 130B. The collaboration widgets allow communication (e.g., including transmission of media content) between the client devices 130A and 130B and the remote server 120 (and therefore between the client devices 130A and 130B via the remote server 120) via a collaboration user interface that enables the shared viewing/manipulating of media files from arbitrary sources without requiring any particular software installed on the respective client devices 130A and 130B. For example, collaboration widgets could update the view of a media file on a client device 115A or 115B based on changes to the view of a file by customer 110A or sales agent 110B and transmit (e.g., periodically or trigger-based) information regarding the changes to the remote server 120 accordingly. In a similar manner, the collaboration widgets could poll the remote server 120 (or vice-versa) for information regarding changes to the view of a file by customer 110A or sales agent 110B and transmit this information to the client device 115A or 115B (e.g., to the one that did not make the change) so that the client device 115A or 115B can update its view of the shared media file to incorporate the changes. Although only the dual client device situation is described here, an arbitrary number of client devices could collaborate with each other via such collaboration widgets.

### Session Data

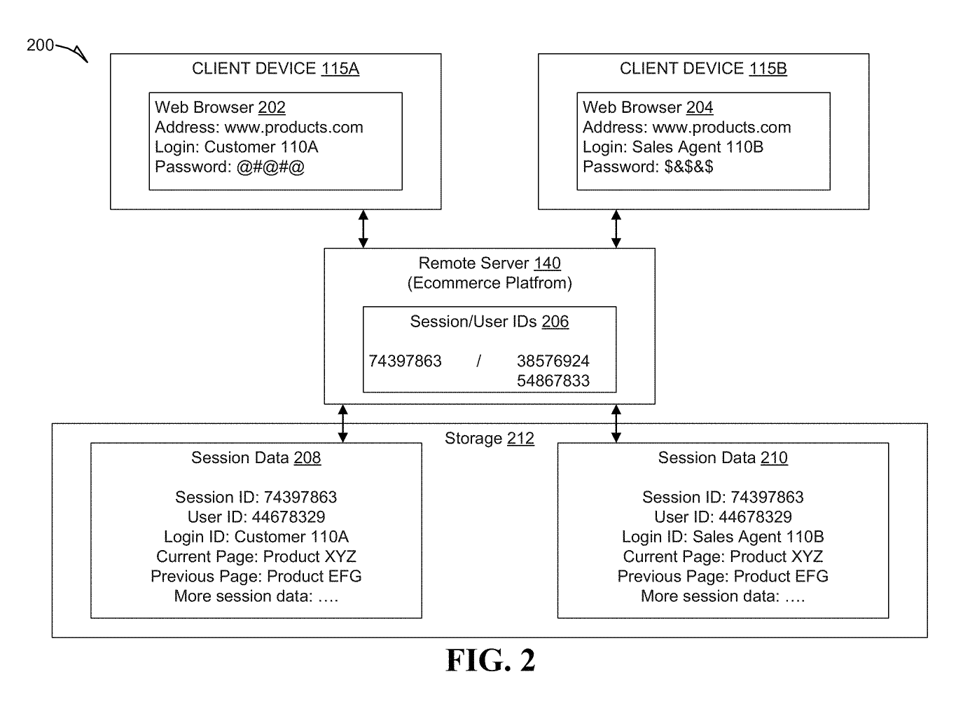

FIG. 2 is a block diagram depicting a network system 200 having a client-server architecture, according to one embodiment, configured to provide a collaboration environment for the hosting of collaborative browsing sessions. The elements in FIG. 2 include some elements from FIG. 1; these elements are labeled with the same identifiers. At least one platform server 140 supports an ecommerce platform that hosts an e-commerce website visited by a client device 115A of customer 110A during a first browsing session. A web browser 202 of client device 115A includes files storing data input by customer 110A such as, for example, an address of the e-commerce website (e.g., www.products.com), and a login and password for customer 110A. The first browsing session can be a collaborative browsing session (as explained above) with a client device 115B of a sales agent 110B associated with the e-commerce website. A web browser 204 of client device 115B includes files storing data input by sales agent 110B such as, for example, a login and password for sales agent 110B. The platform server 140 may store respective session IDs and user IDs for the first browsing session, the customer 110A and the sales agent 110B. As noted above, these IDs can be included in requests from client devices 115A and 115B to the platform server 140 during the first browsing session.

The platform server 140 may also store (e.g., in a storage 212) session data 208 and session data 210 associated with the first browsing session. The session data 208 is associated with customer 110A via a user ID (e.g., 38576924) and with the first browsing session via a session ID (e.g., 74397863). The session data 208 can include data regarding arbitrary aspects of customer 110A's activities and/or behaviors during the first browsing session (e.g., products viewed or searched) along with certain metadata associated with those activities and/or behaviors (e.g., length of search or pattern of search). The session data 208 can also include “state” information associated with the first browsing session at the e-commerce website, such as: the last page of the website that customer 110A visited or what actions the user took on a page of the website (e.g., adding an item to a shopping cart or filling in information on a website form). As noted above, the first browsing session can be a collaborative browsing session with a client device 115B of a sales agent 110B and therefore session data 210 associated with sales agent 110B via a user ID (e.g., 54867833) and with the first browsing session via a session ID (e.g., 74397863), can also be stored. The session data 210 can include data regarding arbitrary aspects of sales agent 110B's activities and/or behaviors during the first browsing session (e.g., products suggested to customer 110A) along with certain metadata associated with those activities and/or behaviors (e.g., did suggested product result in a purchase by customer 110A).

### System Architecture

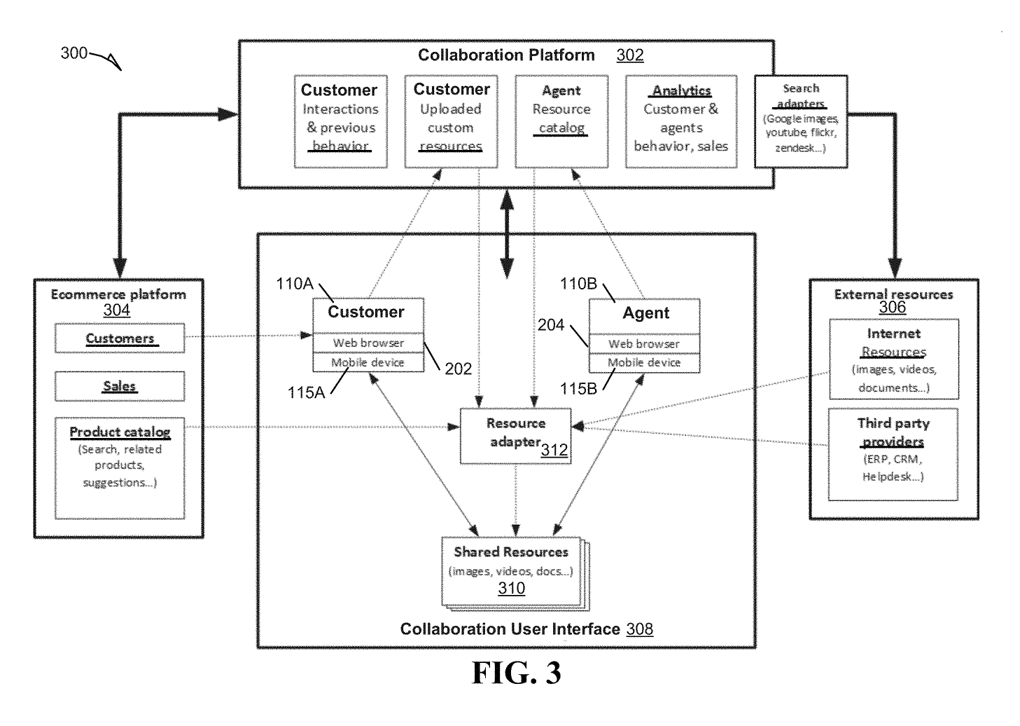

FIG. 3 is a block diagram depicting a network system 300 having a client-server architecture, according to one embodiment, configured to provide a collaboration environment for the shared viewing and manipulating of media files. The elements in FIG. 3 include some elements from FIGS. 1 and 2, and these elements are labeled with the same identifiers. A collaboration platform 302 (e.g., a collaboration module residing on at least one remote server 120) is configured to communicate with two or more client devices 115A and 115B associated with customer 110A and sales agent 110B, respectively. The collaboration platform 302 is also configured to communicate with an ecommerce platform 304 (e.g., an ecommerce module residing on at least one platform server 140) that hosts an e-commerce website visited by customer 110A during a first browsing session. The ecommerce platform 304 also stores data regarding a “Product catalog” (e.g., products available for purchase on the e-commerce website), “Sales” (e.g., at the e-commerce website) and “Customers” (e.g., that have visited or made purchases on the website). The collaboration platform 302 can access session data (including session state data) from the first browsing session of the customer 110A at the e-commerce website or other data associated with customer 110A (e.g., contact information) from the “Customers” data at the ecommerce platform 304. The collaboration platform 302 can store the accessed data associated with customer 110A and the first browsing session as, for example, as “Interactions and previous behavior” of customer 110A with the ecommerce platform 304.

The collaboration platform 302 can then determine, based on the “Interactions and previous behavior” of customer 110A (including the data from the first browsing session), that the customer 110A would like to collaborate with a sales agent 110B (e.g., the customer 110A has searched several products without making a purchase, unlike in previous interactions). The selection of sales agent 110B for collaboration with customer 110A may be based on “Analytics” comprising an analysis of the behaviors (including past sales) of the sales agent 110B and the customer 110A or other customers determined to be similar to customer 110A. The collaboration platform 302 may identify the sales agent 110B (for collaboration with customer 110A) based on sales agent information obtained from the ecommerce platform 304. The sales agent information can indicate, for example, an association between the sales agent 110B and the ecommerce platform 304 (e.g., or an association with a particular e-commerce website of the ecommerce platform 304), an association between the sales agent 110B and the metadata associated with a data file (e.g., a manufacturer associated with the data file), or the sales agent information can indicate previous collaborations between the customer 110A and the sales agent 110B or a previous collaboration between the customer 110A and a virtual (e.g., non-human artificial intelligence) sales agent. This sales agent information may already be available to the collaboration platform 302 by being previously stored as “Analytics” in the collaboration platform 302. Furthermore, the sales agent information stored as “Analytics” can include a selected preference of the sales agent 110B, information associated with an employer of the sales agent 110B, or information associated with data files previously viewed by the sales agent 110B in a collaboration user interface 308 provided via the collaboration platform 302.

The collaboration platform 302 can then retrieve a first data file from the ecommerce platform 304 (e.g., from the “Product catalog”) based on the first browsing session data (e.g., a data file associated with a product that the customer 110A has viewed or searched during the first browsing session at the e-commerce website) and the interactions and previous behavior of customer 110A (e.g., the customer 110A usually prefers a certain brand). The collaboration platform 302 then determines a data type of the first data file (e.g., an image format, document format, or video format) and also accesses, from the ecommerce platform 304, metadata associated with the first data file (e.g., how many times it has been viewed or a business associated with the data file). The collaboration platform 302 can then identify one or more shared resources 310 of data files from external resources 306, from “Uploaded custom resources” comprising data files stored at the collaboration platform 302 by customer 110A (or another customer determined to be similar), or from a “Resource catalog” comprising data files stored at the collaboration platform 302 by sales agent 110B based on the data type and the metadata (e.g., similar files that are the most popular or otherwise relevant). The external resources 306 of data files may include nearly any source of data files that can be searched using “Search adapters” located at the collaboration platform 302, such as “Internet Resources” of images, documents, videos, etc., or “Third party providers” of such files, e.g., a Customer Relationship Management (CRM) system of third-party enterprises.

The above-noted sales agent information (used to select sales agent 110B for a collaborative browsing session) can also be used to identify the one or more sources of data files (e.g., from external resources 306, or from the “Uploaded custom resources” and “Resource catalog” of the collaboration platform 302) that may be presented to the customer 110A and the sales agent 110B, such as the first data file, for shared viewing/manipulating in the collaboration user interface 308. For example, sources including products sold by an employer of the sales agent might be selected. Furthermore, a customer relationship management (CRM) system or enterprise resource planning (ERP) of an employer of the sales agent may be selected as a source of data files for shared viewing/manipulating in a collaboration user interface 308 by customer 110A and the sales agent 110B.

The collaboration platform 302 can then generate the collaboration user interface 308 providing: options (e.g., user interface elements) for viewing and manipulating the first data file in the respective web browsers 202 and 204 of client devices 115A and 115B by making use of a resource adapter 312 to modify the format of the first data file if that is necessary (or even just helpful, such as for faster processing) for viewing and manipulating the file in the web browsers 202 and 204. The collaboration platform 302 also provides (in the collaboration user interface 308) a user-selectable list of the one or more shared resources 310 of data files that may be jointly viewed and manipulated by the customer 110A and the sales agent 110B. As noted above, different collaboration widgets may be transmitted to the client devices of the customer 110A and the sales agent 110B. For example, a collaboration widget for the client device 115B of sales agent 110B may provide access to additional features in the collaboration user interface 308, such as a display of a status indicator for customer 110A based on an activity of the customer 110A in a specified context. If the context is an e-commerce website (e.g., of the ecommerce platform 304), then the activity could be adding a product to a shopping cart or purchasing a product, and the indicators for each could be “purchasing” or “purchased”. Alternatively, some activities could result in a status indicator in any context, such as minimizing or exiting the collaboration user interface 308, both of which could be indicated by “not interested” or some other similar indicator.

The collaboration user interface 308 makes use of the resource adapter 312 in order to provide an arbitrary list of user-selectable links to individual data files (e.g., an image or video file) or links to searchable collections of data files, because the resource adapter 312 allows the viewing/manipulating of data files to not be limited by the capabilities of the respective client devices 115A and 115B. For example, the resource adapter 312 may comprise an adapter library (e.g., from the collaboration platform 302) for adapting at least one data type (e.g., an image or video file format) of at least one data file associated with the user-selectable links. Then, based on a selection of a link by the customer 110A or sales agent 110B, options may be provided (e.g., in the collaboration user interface 308) for viewing and manipulating a data file associated with the selected link or a browser option (e.g., via web browsers 202 and 204) for searching a collection of data files associated with the selected link.

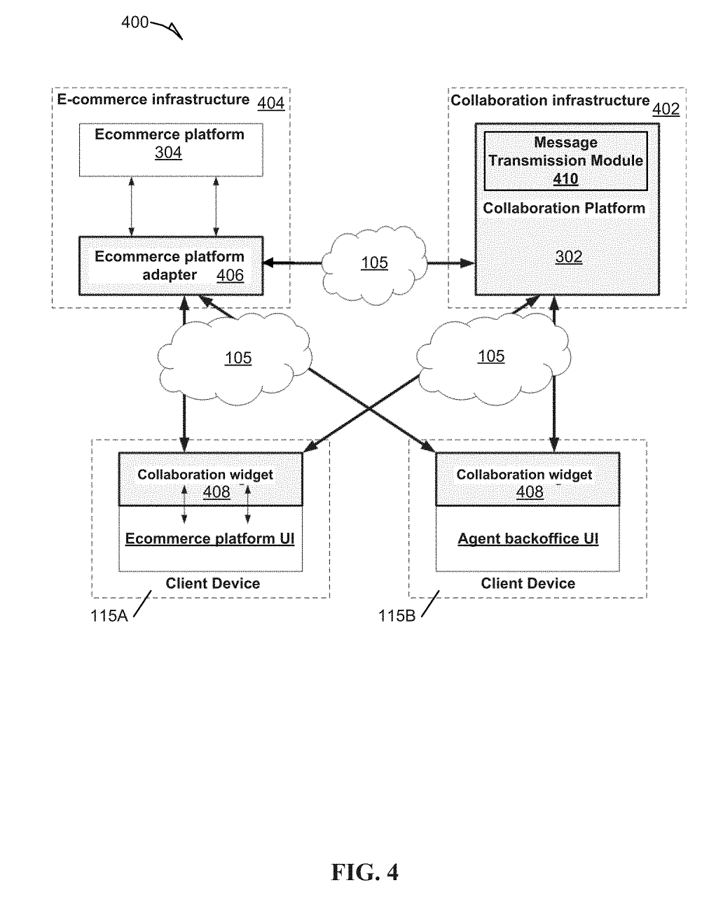

FIG. 4 is a block diagram depicting a network system 400 having a client-server architecture, according to one embodiment, configured to provide a collaboration environment for the shared viewing and manipulating of media files. The elements in FIG. 4 include some elements from FIGS. 1-3, and these elements are labeled with the same identifiers. The ecommerce platform 304 is part of an e-commerce infrastructure 404 that includes an ecommerce platform adapter 406 (e.g., an application programming interface “API”) for communicating with the collaboration platform 302, which is part of a collaboration infrastructure 402. The customer 110A may be browsing (e.g., in the first browsing session) products available on the ecommerce platform 304 via a user interface “UI” such as an “Ecommerce platform UI” displayed on the web browser 202 of client device 115A of customer 110A. The collaboration platform 302 can determine, based on accessed session and customer data as explained above, or based on a request from customer 110A, that the customer 110A would like to collaborate with a sales agent 110B. The collaboration platform 302 may transmit (e.g., via a message transmission module 410) a first collaboration widget 408 to the client device 115A and a second (possibly different) collaboration widget 408 to the client device 115B of sales agent 110B (if the client device 115B does not already have the collaboration widget 408 installed). The sales agent 110B may receive a notice (e.g., together with the collaboration widget 408) that customer 110A wants to collaborate in an “Agent backoffice UI” displayed on the web browser 204 of client device 115B. The two collaboration widgets 408 are configured to interface with the “Ecommerce platform UI” and the “Agent backoffice UI” respectively, and to communicate with the ecommerce platform adapter 406 and the collaboration platform 302, e.g., over network 105.

The collaboration platform 302 may generate the collaboration widgets 408 to transmit to the customer device 115A or agent device 115B based on detected capabilities of the customer device 115A or agent device 115B (e.g., capabilities of web browsers 202 and 204). The collaboration widgets 408 provide any missing capabilities to the customer device 115A or agent device 115B in order to enable a visual communication with the collaboration platform 302 without requiring either the customer device 115A or agent device 115B to have any other executable files pre-installed. After the customer device 115A and the agent device 115B have received the collaboration widget 408, the customer device 115A and the agent device 115B can access the collaboration user interface 308 generated by the collaboration platform 302 so that a link is established between the customer device 115A, the collaboration platform 302, and the agent device 115B for shared viewing and manipulation of files in the collaboration user interface 308 during the first browsing session, which is now a collaborative browsing session. The collaboration user interface 308 is displayed on the web browsers 202 and 204 of customer device 115A and the agent device 115B enabling a shared view of media files. In this way, both the customer 110A and the agent 110B can view/manipulate the same content (e.g., media files) displayed on their respective web browsers 202 and 204.

Both the customer 110A and the agent 110B can manipulate the shared view in the collaboration user interface 308 during the collaborative browsing session. For example, the agent 110B can change the shared view in the collaboration user interface 308 from media content at one universal resource locator (“URL”) source location to content at a second URL source location. Any such changes are communicated to the collaboration platform 302 via the collaboration widget 408, and the collaboration platform 302 subsequently transmits the changes to the collaboration widget 408 on the customer device 115A, which then implements the change in the collaboration user interface 308 displayed on the customer device 115A. The collaboration widget 408 on the customer device 115A may also notify the collaboration platform 302 that the change has been implemented on the customer device 115A. Of course, this process can be performed bi-directionally, so that the customer device 115A can change the shared view in the collaboration user interface 308 and cause a conforming change on the agent device 115B via the collaboration widget 408 and collaboration platform 302.

After the customer 110A has ended the first browsing session at the e-commerce website, the collaboration platform 302 can determine, for example based on an analysis of the accessed session data for the first browsing session (e.g., no purchase was made after extended browsing) and the customer data (e.g., this is unusual for the customer 110A), that the customer 110A was not satisfied with the results of the first browsing session or might be interested in further product suggestions. This determination by the collaboration platform 302 may also be made based on input from the sales agent 110B, for example based on new data (e.g., product that might satisfy a stated or implied desire of the customer) discovered by the sales agent 110B that might be helpful in steering the customer 110A towards a purchase during a second browsing session at the e-commerce website or at another related or similar website. The collaboration platform 302, via transmission module 410 (or the sales agent 110B from client device 115B) can then transmit a message (e.g., e-mail or text message) to the client device 115A of customer 110A (e.g., based on accessed contact information), the message including a summary of the first browsing session. The summary of the first browsing session can include a list of viewed or searched products and a suggestion (e.g., based on input from sales agent 110B or based on analysis of historical sales data for customer 110A or customers similar to customer 110A) regarding a product or type of product that the customer may want to investigate (or further investigate if already viewed or searched in first browsing session) in a second browsing session at the e-commerce website or at another related or similar website.

In order to facilitate such a second browsing session, the collaboration platform 302 can include, in the transmitted message, a link that, when selected by customer 110A, opens the web browser 202 of client device 115A directly to the suggested product(s) in the second browsing session. For example, the link can include (e.g., as embedded data in a URL address of the e-commerce website) session state data for an initial session state of the second browsing session. In an embodiment, the initial session state of the second browsing session can include a browsing history based on the products searched in the first browsing session. The second browsing session could begin with a specified product (e.g., a product suggested by sales agent 110B) already in a shopping cart of the e-commerce website and delivery information already input into a form of the e-commerce website based on session data from the first browsing session or accessed customer data regarding customer 110A. Furthermore, the second browsing session could be a collaborative browsing session that begins in a collaborative mode (using collaboration widgets 408 still installed on the client devices 115A and 115B or re-transmitting them if necessary, e.g., based on a data type of a file associated with a suggested product) with the sales agent 110B based on a request from customer 110A or based on the accessed session data of the first browsing session (e.g., customer 110A collaborated with the sales agent 110B during the first browsing session) or based on historical data regarding customer 110A indicating that customer 110A has collaborated successfully with the sales agent 110B (or other similar sales agents) during previous collaborative browsing sessions. In this way, the second browsing session can continue where the first browsing session left off with a simple click on the link provided in the transmitted message including the summary of the first browsing session.

This results, essentially, in a rapid re-hosting (e.g., just one click) of the first browsing session (e.g., as the second browsing session) for customer 110A, with no need to search for previously viewed products or fill in previously input information or even request help again from the sales agent 110B. Furthermore, the collaboration platform 302 can, via the message transmission module 410, transmit a message including a summary of the first or second browsing sessions (or both) to the sales agent 110B based on the first user making a purchase at the e-commerce website (or at another website while collaborating with sales agent 110B) during the first or second browsing sessions. The message transmitted to sales agent 110B may be viewed in collaboration user interface 308 and may be accompanied by a status indicator for customer 110A (such as “purchase made”) that is viewable in the collaboration user interface 308 by sales agent 110B using a “sales agent” specific collaboration widget 408.

### Methods

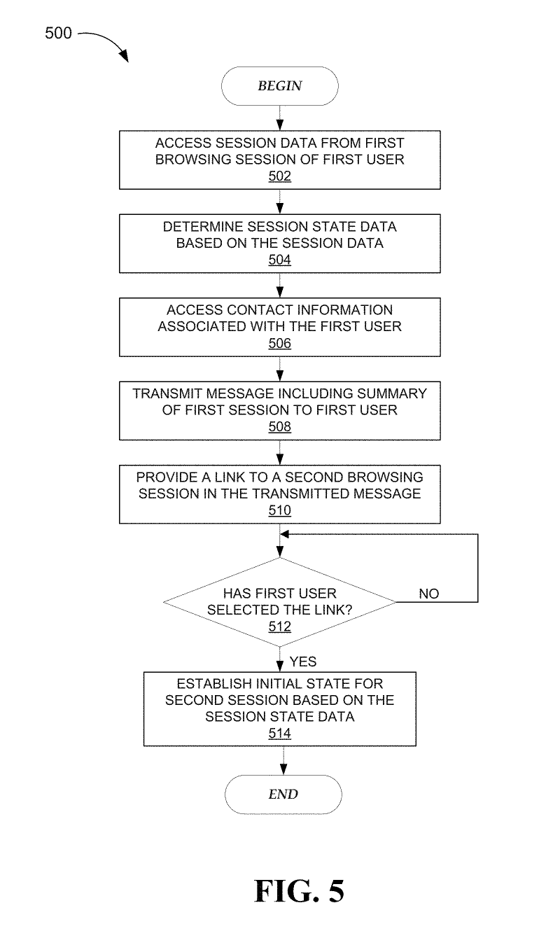

FIG. 5 shows a flow diagram illustrating one example embodiment of a method 500 for the rapid re-hosting of collaborative browsing sessions. At operation 502, session data regarding a first browsing session of a first user (e.g., customer 110A) at an enterprise's website (e.g., an e-commerce website) is accessed (e.g., by collaboration platform 302). At operation 504, session state data (e.g., current web page at enterprise website) is determined based on the data regarding the first browsing session. The session state data may include data regarding the state of the first browsing session at different times during the first browsing session. At operation 506, customer data regarding the customer 110A is accessed form the enterprise (e.g., from ecommerce platform 304 of the enterprise) by the collaboration platform 302 if the data is not already stored at the collaboration platform 302. The accessed customer data can include, for example, contact information associated with customer 110A. The collaboration platform 302 can then, at operation 508, transmit a message to customer 110A (e.g., at the end of the first browsing session) based on the accessed contact information for customer 110A. The message includes a summary of the first browsing session, such as a list of products viewed during the first browsing session sorted according to how popular each product is among other customers or sorted according to input received from a sales agent (e.g., sales agent 110B) that has collaborated with the customer 110A during the first browsing session (or previous browsing sessions).

At operation 510, the collaboration platform 302 can provide a link to a second browsing session (e.g., at the e-commerce website) within the transmitted message. The second browsing session can have an initial state that is based on the session state data from the first browsing session. For example, the second browsing session can begin as a collaborative browsing session between customer 110A and sales agent 110B based on a collaboration between the customer 110A and sales agent 110B during the first browsing session. In this way, the collaborative first browsing session can be rapidly re-hosted (as the second browsing session) by the e-commerce website and the collaboration platform 302 based on a selection of the link in the transmitted message by customer 110A. At operation 512 it is determined by the collaboration platform 302 whether the customer 110A has selected the link in the transmitted message. If the customer 110A has not selected the link, the method 500 returns to operation 512 and continues to wait for the customer 110A to select the link. If the customer 110A has selected the link, the method 500 proceeds to operation 514 and begins the second browsing session at the e-commerce website (or at another website) with an initial session state that is based on the accessed session and customer data for the first browsing session and the customer 110A. The initial session state for the second browsing session can also be based on information input by the sales agent 110B, for example, based on the first browsing session being a collaborative browsing session between the customer 110A and sales agent 110B.

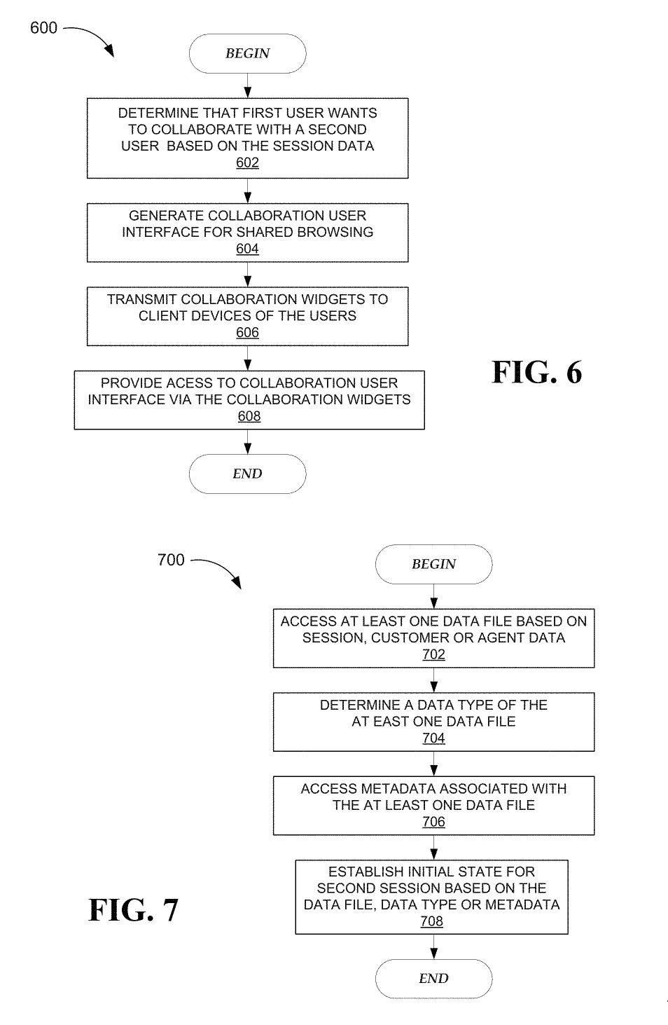

FIG. 6 shows a flow diagram illustrating one example embodiment of a method 600 for the rapid re-hosting of collaborative browsing sessions. At operation 602, it is determined (e.g., by the collaboration platform 302) that a first user (e.g., customer 110A) wants to collaborate with a second user (e.g., sales agent 110B) based on accessed session data from a previous browsing session of the customer 110A (e.g., the first browsing session). For example the customer may have collaborated with the sales agent 110B in the first browsing session. At operation 604, the collaboration platform 302 can generate a collaboration user interface 308 that provides options (e.g., user interface elements) for shared viewing and manipulating of media files. At operation 606, the collaboration platform 302 transmits (e.g., via message transmission module 410) collaboration widgets 408 to client devices 115A and 115B of customer 110A and sales agent 110B respectively. The collaboration widgets 408 for each client device (115A and 115B) can be different based on the identity of the respective user (customer 110A and sales agent 110B) or based on the capabilities of web browsers 202 and 204 of the client devices 115A and 115B respectively. At operation 608, the collaboration platform 302 can provide access to the collaboration user interface 308 to client devices 115A and 115B via the respective collaboration widget 408 transmitted to each device. For example, the client device 115B may be able to access elements of the collaboration user interface 308 that are not visible to client device 115A based on the client device 115B being associated with the sales agent 110B.

FIG. 7 shows a flow diagram illustrating one example embodiment of a method 700 for the rapid re-hosting of collaborative browsing sessions. At operation 702, at least one data file is retrieved by the collaboration platform 302 (e.g., from the ecommerce platform 304) based on accessed session data from a previous browsing session of the customer 110A (e.g., the first browsing session) or based on accessed customer data regarding customer 110A (e.g., including data input by sales agent 110B as a suggestion for customer 110A). For example, the collaboration platform 302 can retrieve, from the ecommerce platform 304, a file associated with a product that customer 110A viewed for an extended period of time during the first browsing session. At operation 704, the collaboration platform 302 can determine a data type of the file retrieved from the ecommerce platform 304. For example, the format of an image or video file associated with the product that customer 110A viewed for an extended period of time during the first browsing session is determined. At operation 706, metadata associated with the at least one data file retrieved by the collaboration platform 302 (e.g., from the ecommerce platform 304) is accessed. The metadata may include, for example, data regarding the popularity of the product associated with the at least one retrieved file or how highly reviewed the product associated with the at least one retrieved file is by customers of the e-commerce website. At operation 708, the collaboration platform 302 can establish the initial session state of the second browsing session at the e-commerce website (or at another website) based on the data type and metadata associated with the at least one retrieved file. For example, the initial session state for the second browsing session can comprise a video player (e.g., based on the data type of a retrieved video file) and an indication of the popularity or reviewed status of the product associated with the at least one retrieved file (e.g., based on which will be more likely to lead to a purchase by the customer 110A).

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via the network 105 (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed in various example embodiments.

### Example Computer System

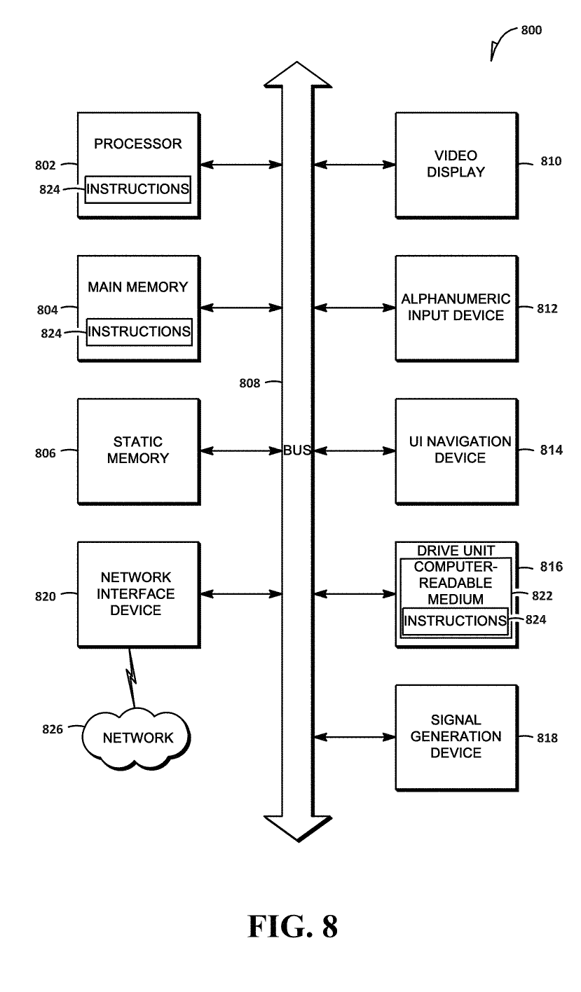

FIG. 8 shows a diagrammatic representation of a machine in the example form of a machine or computer system 800 within which a set of instructions 824 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 824 (sequential or otherwise) that specify actions to be taken by that machine. Further, while only a single machine is illustrated, the term “machine” shall also be taken to include any collection of machines that individually or jointly execute a set (or multiple sets) of instructions 824 to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a UI navigation device 814 (e.g., a mouse), a drive unit 816, a signal generation device 818 (e.g., a speaker), and a network interface device 820.

The drive unit 816 includes a computer-readable medium 822 on which is stored one or more sets of data structures and instructions 824 (e.g., software) embodying or used by any one or more of the methodologies or functions described herein. The instructions 824 may also reside, completely or at least partially, within the main memory 804 or within the processor 802 during execution thereof by the computer system 800, with the main memory 804 and the processor 802 also constituting machine-readable media.

The instructions 824 may further be transmitted or received over a network 826 via the network interface device 820 utilizing any one of a number of well-known transfer protocols (e.g., HTTP).

While the computer-readable medium 822 is shown in an example embodiment to be a single medium, the term “computer-readable medium” should be taken to include a single medium or multiple media (e.g., a centralized or distributed database, and/or associated caches and servers) that store the one or more sets of instructions 824. The term “computer-readable medium” shall also be taken to include any medium that is capable of storing, encoding, or carrying a set of instructions 824 for execution by the machine that cause the machine to perform any one or more of the methodologies of the present disclosure, or that is capable of storing, encoding, or carrying data structures used by or associated with such a set of instructions 824. The term “computer-readable medium” shall, accordingly, be taken to include, but not be limited to, solid-state memories, optical media, and magnetic media.

Furthermore, the machine-readable medium is non-transitory in that it does not embody a propagating signal. However, labeling the tangible machine-readable medium “non-transitory” should not be construed to mean that the medium is incapable of movement—the medium should be considered as being transportable from one physical location to another. Additionally, since the machine-readable medium is tangible, the medium may be considered to be a machine-readable device.

### Example Mobile Device

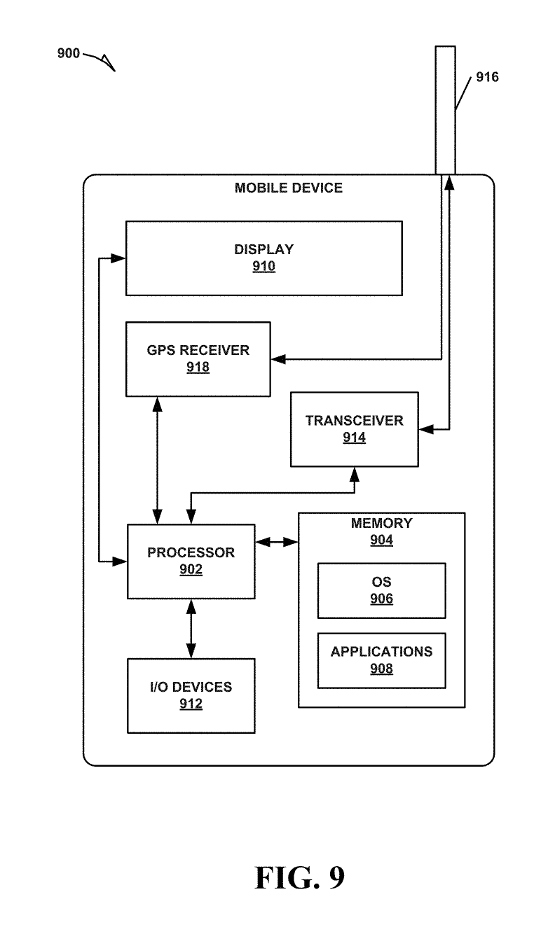

FIG. 9 is a block diagram illustrating a mobile device 900, according to an example embodiment. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or another type of memory, is typically accessible to the processor 902. The memory 904 may be adapted to store an operating system (OS) 906, as well as applications 908, such as a mobile location-enabled application that may provide location-based services (LBSs) to a user. The processor 902 may be coupled, either directly or via appropriate imaging hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

Such embodiments of the inventive subject matter may be referred to herein, individually or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A system comprising:
at least one server configured to communicate with two or more client devices;
a collaboration module, implemented by the at least one server, and configured to:
access session data from a first browsing session of a first user of a first client device, of the two or more client devices, at a website of an enterprise; and
determine session state data for the first browsing session based on the session data; and
a message transmission module, implemented by the at least one server, and configured to:
access, from the enterprise, first user information associated with the first user, the first user information including contact information;
transmit a message including a summary of the first browsing session to the first user based on the session data and the first user information; and
provide, in the message, a link to a second browsing session at the website; and
the collaboration module being further configured to:
based on a selection of the link by the first user, use the session state data to establish an initial session state for the second browsing session.

2. The system of claim 1, wherein the initial session state for the second browsing session includes a browsing history of the first browsing session.

3. The system of claim 1, wherein the collaboration module is further configured to:
determine that the first user would like to collaborate with a second user of a second client device of the two or more client devices, based on the session data indicating that the first user has collaborated with the second user during the first browsing session;
generate a collaboration user interface providing options for viewing and manipulating data files;
transmit a first collaboration widget to the first device and a second collaboration widget to the second device;
provide the first and second client devices with access to the collaboration user interface using the first and second collaboration widgets respectively; and
establish the initial session state for the second browsing session based on data received from the second user.

4. The system of claim 3, wherein the collaboration module is further configured to determine that the first user would like to collaborate with the second user based on a request from the first user.

5. The system of claim 3, wherein the collaboration module is further configured to:
access at least one data file based on at least one of the session data, the first user information and the data received from the second user;
determine a data type of the at least one data file;
access metadata associated with the at least one data file; and
establish the initial session state for the second browsing session based on one or more of the at least one data file, the data type and the metadata.

6. The system of claim 5, wherein the collaboration module is further configured to:
identify one or more sources of data files based on one or more of the at least one data file, the data type and the metadata; and
establish the initial session state for the second browsing session by providing: options for viewing and manipulating the at least one data file, and a user-selectable list of the one or more sources of data files

7. The system of claim 6, wherein the collaboration module is further configured to identify the one or more sources of data files based on the data received from the second user.

8. The system of claim 7, wherein the data received from the second user comprises: a selected preference of the second user, information associated with an employer of the second user, or information associated with data files previously viewed by the second user in the collaboration user interface.

9. The system of claim 5, wherein the collaboration module is further configured to identify the second user based on second user information accessed from the enterprise, the second user information indicating an association between the second user and the enterprise website, indicating an association between the second user and the metadata associated with the at least one data file, or indicating previous collaborations between the first user and the second user.

10. The system of claim 5, wherein:
the second user is a sales agent;
the website comprises an e-commerce website;
the at least one data file comprises an image or a video that depicts a product available for purchase at the e-commerce website; and
the message transmission module is further configured to transmit a message including a summary of the first or second browsing sessions to the second user based on the first user making a purchase at the e-commerce website during the first or second browsing sessions.

11. A method implemented by at least one server and comprising:
accessing session data from a first browsing session of a first user of a first client device at a website of an enterprise;
determining session state data for the first browsing session based on the session data;
accessing, from the enterprise, first user information associated with the first user, the first user information including contact information;
transmitting a message including a summary of the first browsing session to the first user based on the session data and the first user information;
providing, in the message, a link to a second browsing session at the enterprise web site; and
based on a selection of the link by the first user, using the session state data to establish an initial session state for the second browsing session.

12. (canceled)

13. The method of claim 11, further comprising:
determining that the first user would like to collaborate with a second user of a second client device, based on the session data indicating that the first user has collaborated with the second user during the first browsing session;
generating a collaboration user interface providing options for viewing and manipulating data files;
transmitting a first collaboration widget to the first device and a second collaboration widget to the second device;
providing the first and second client devices with access to the collaboration user interface using the first and second collaboration widgets respectively; and
establish the initial session state for the second browsing session based on data received from the second user.

14. (canceled)

15. The method of claim 13, further comprising:
accessing at least one data file based on at least one of the session data, the first user information and the data received from the second user;
determining a data type of the at least one data file;
accessing metadata associated with the at least one data file; and
establishing the initial session state for the second browsing session based on one or more of the at least one data file, the data type and the metadata.

16. The method of claim 15, further comprising:
identifying one or more sources of data files based on one or more of the at least one data file, the data type and the metadata; and
establishing the initial session state for the second browsing session by providing: options for viewing and manipulating the at least one data file, and a user-selectable list of the one or more sources of data files

17. (canceled)

18. The method of claim 16, further comprising identifying the one or more sources of data files based on the data received from the second user;
wherein the data received from the second user comprises: a selected preference of the second user, information associated with an employer of the second user, or information associated with data files previously viewed by the second user in the collaboration user interface.

19. The method of claim 15, further to comprising identifying the second user based on second user information accessed from the enterprise, the second user information indicating an association between the second user and the enterprise website, indicating an association between the second user and the metadata associated with the at least one data file, or indicating previous collaborations between the first user and the second user.

20. The method of claim 15, wherein:
the second user is a sales agent;
the website comprises an e-commerce website;
the at least one data file comprises an image or a video that depicts a product available for purchase at the e-commerce website; and
the method further comprising transmitting a message including a summary of the first or second browsing sessions to the second user based on the first user making a purchase at the e-commerce website during the first or second browsing sessions.

21. A non-transitory computer-readable medium storing program code which, when executed by at least one processor of a server, is operative to cause the server to perform the steps of:
accessing session data from a first browsing session of a first user of a first client device at a website of an enterprise;
determining session state data for the first browsing session based on the session data;
accessing, from the enterprise, first user information associated with the first user, the first user information including contact information;
transmitting a message including a summary of the first browsing session to the first user based on the session data and the first user information;
providing, in the message, a link to a second browsing session at the enterprise web site; and
based on a selection of the link by the first user, using the session state data to establish an initial session state for the second browsing session.

22. The computer-readable medium of claim 18, the steps further comprising:
determining that the first user would like to collaborate with a second user of a second client device, based on the session data indicating that the first user has collaborated with the second user during the first browsing session;
generating a collaboration user interface providing options for viewing and manipulating data files;
transmitting a first collaboration widget to the first device and a second collaboration widget to the second device;
providing the first and second client devices with access to the collaboration user interface using the first and second collaboration widgets respectively; and
establish the initial session state for the second browsing session based on data received from the second user.

23. The computer-readable medium of claim 19, the steps further comprising:
accessing at least one data file based on at least one of the session data, the first user information and the data received from the second user;
determining a data type of the at least one data file;
accessing metadata associated with the at least one data file; and
establishing the initial session state for the second browsing session based on one or more of the at least one data file, the data type and the metadata.
